(19) United States
(12) Patent Application Publication
(10) Pub. No.: US 2014/0060496 A1
(43) Pub. Date: Mar. 6, 2014

(54) System and Method for Controlling LPG Pump and Fuel Supplying System of LPI Engine Using Thereof

(71) Applicant: HYUNDAI MOTOR COMPANY, Seoul (KR)

(72) Inventors: Chang Ho Ham, Ansan-city (KR); Pil Seon Choi, Anyang-si (KR)

(73) Assignee: Hyundai Motor Company, Seoul (KR)

(21) Appl. No.: 13/708,817

(22) Filed: Dec. 7, 2012

(30) Foreign Application Priority Data
Sep. 6, 2012 (KR) 10-2012-0098870

(51) Int. Cl. F02M 51/04

(52) U.S. Cl. CPC F02M 51/04
USPC 123/497

(57) ABSTRACT

A method of controlling a liquefied petroleum gas (LPG) fuel pump may include driving a motor of the LPG fuel pump with a voltage of a predetermined duty, measuring a driving speed of the motor, changing the predetermined duty of the motor so that the measured driving speed of the motor reaches a target speed when the measured driving speed of the motor may be not equal to the target speed, measuring pressure of an LPG bombe and pressure of an injector, and changing the target speed when a first difference between the measured pressure of the LPG bombe and the measured pressure of the injector may be not maintained as a first predetermined value.

### CROSS-REFERENCE TO RELATED APPLICATION

The present application claims priority to Korean Patent Application No. 10-2012-0098870 filed on Sep. 6, 2012, the entire contents of which is incorporated herein for all purposes by this reference.

### BACKGROUND OF THE INVENTION

1. Field of the Invention

The present invention relates to a system and a method for controlling a liquefied petroleum gas (LPG) fuel pump for delivering an LPG fuel, and a fuel supply system of a liquefied petroleum injection (LPI) engine to which the LPG fuel pump control system is applied.

2. Description of Related Art

FIG. 1 is a configuration diagram of a liquefied petroleum injection (LPI) fuel storage and supply system in the related art.

As show in FIG. 1, the LPI fuel storage and supply system 1 in the related art generally includes an LPG bombe 2 for storing an LPG fuel, an LPG fuel pump 3 for delivering the stored LPG fuel, a pump controller 4 for controlling the LPG fuel pump 3, a fuel supply line 6 for supplying the fuel of the LPG bombe 2 to an injector 10 of an engine 5, a return line 7 for collecting the fuel of the engine to the LPG bombe 2, and a regulator valve 8 installed at the return line 7.

The LPG fuel storage and supply system in the related art employs a return type method, in which the residual fuel that is not used by the engine among the fuel delivered from the LPG bombe 2 to the engine 5 returns to the LPG bombe through the return line 7.

In the return type method, since more fuel than the amount of fuel consumption of the engine is delivered in consideration of a safety rate, a large amount of return fuel is generated during a low load idle state. In general, the LPG fuel pump delivers the amount of fuel equal to or larger than a sum of the fuel consumption of the engine and the safety rate.

However, in a case of the fuel pump control method in the related art, since a flow rate of the fuel pump is divided into five steps and the flow rate is controlled for each step, there is a problem in that it is impossible to control the flow rate of the fuel pump at an rpm smaller than an rpm (for example, 425 rpm) of a motor in the first step that is the lowest step.

Accordingly, a large amount of return fuel is generated due to the failure of the minimization of the flow rate of the pump in the low load idle state in the related art. Since the large amount of the return fuel is heated by the engine 5, as a time goes by, a temperature inside the LPG bombe 2 increases and thus a pressure inside the bombe simultaneously increases, such that poor filling is generated when the LPG fuel is refilled. Further, there is a problem in that noise is generated in the LPG fuel pump 3 due to the excessive return flow rate and an operation of the pump, and durability of the LPG fuel pump 3 is deteriorated.

In the meantime, in order to solve the problem, if performance of the LPG fuel pump 3 is generally decreased, the amount of return fuel is decreased in a low load area and thus the temperature inside the LPG bombe 2 is lowered, but a problem of deteriorating performance by the engine in a high load area is generated. Accordingly, a method for solving the contradictory situation is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an LPG fuel pump control system and method of preventing poor LPG filling, noise generation, and durability deterioration in a low load area and exhibiting sufficient engine performance in a high load area by driving the LPG fuel pump as much as necessity in an engine, and a fuel supply system of an LPI engine using the same.

In an aspect of the present invention, a method of controlling a liquefied petroleum gas (LPG) fuel pump, may include driving a motor of the LPG fuel pump with a voltage of a predetermined duty, measuring a driving speed of the motor, changing the predetermined duty of the motor so that the measured driving speed of the motor reaches a target speed when the measured driving speed of the motor is not equal to the target speed, measuring pressure of an LPG bombe and pressure of an injector, and changing the target speed when a first difference between the measured pressure of the LPG bombe and the measured pressure of the injector is not maintained as a first predetermined value.

The method may further include determining whether a second difference between the first difference and the first predetermined value exceeds a second predetermined value and is maintained for a predetermined time, and outputting a predetermined diagnosis signal and changing the duty of the motor, when the second difference is determined to exceed the second predetermined value for the predetermined time.

The pressure of the LPG bombe is measured by a pressure sensor installed at the LPG bombe, wherein the pressure of the bombe is measured by a pressure sensor installed at an engine side, and wherein the duty of the motor is changed by a motor controller.

The motor controller, the pressure sensor installed at the bombe, and the pressure sensor installed at the engine side identify malfunctions and output diagnosis signals, respectively.

The first predetermined value is 3 to 7 bars.

The motor is a sensor-type Brushless direct current (BLDC) motor in which a hall sensor or a photo sensor configured to detect a rotation position of an internal rotor is installed, and the motor controller measures the driving speed of the motor by receiving a position signal of the rotor sensed by the hall sensor or the photo sensor.

In another aspect of the present invention, a system of controlling a liquefied petroleum gas (LPG) fuel pump, may include a motor controller configured to control driving of a motor installed inside the LPG fuel pump, an engine-side pressure sensor configured to measure pressure of an injector installed at an engine to transmit the measured pressure to the motor controller, and a bombe-side pressure sensor configured to measure pressure of an LPG bombe to transmit the measured pressure to the motor controller, wherein the motor controller changes a duty of the motor so that a measured speed of the motor reaches a target speed, receives the measured pressure of the LPG bombe and the measured pressure of the injector, and changes the target speed of the motor so that a first difference between the pressure of the LPG bombe and the pressure of the injector is maintained as a predetermined value.

A second difference between the first difference and the first predetermined value exceeds a second predetermined value and is maintained for a predetermined time, the motor controller outputs a predetermined diagnosis signal and changes the duty of the motor.

The motor is a sensor type Brushless direct current (BLDC) motor in which a hall sensor or a photo sensor configured to detect a rotation position of an internal rotor is installed, and the motor controller measures a speed of the motor by receiving a position signal of the rotor from the motor.

The motor controller, the bombe-side pressure sensor, and the engine-side pressure sensor identify malfunctions and output diagnosis signals, respectively.

The first predetermined value is 3 to 7 bars.

In further another aspect of the present invention, a fuel supply system of a liquefied petroleum injection (LPI) engine, may include the LPG bombe in which an LPG fuel is stored, the LPG fuel pump configured to deliver the fuel of the LPG bombe to the LPI engine, a fuel supply line connected to the LPG fuel pump and to an injector and configured to supply the fuel to the injector of the engine from the LPG bombe, and a fuel return line fluid-connected to the injector and the LPG bombe so that a fuel remaining in the injector is collected to an inside of the LPG bombe, wherein the LPG fuel pump is controlled by the system for controlling the LPG fuel pump.

The fuel supply system may further include a relief valve installed at the return line to maintain pressure of the return line.

The fuel supply system may further include a shut-off valve installed at the fuel supply line.

According to the LPG fuel pump control system and method and the fuel supply system of the LPI engine using the same according to the exemplary embodiment of the present invention, it is possible to minimize a return flow rate by minimizing a speed of the motor in a low load idle area of the engine, so that an increase in a temperature and pressure inside the LPG bombe may be suppressed, thereby preventing a problem of a LPG filling failure.

Further, according to the LPG fuel pump control system and method and the fuel supply system of the LPI engine using the same according to the exemplary embodiment of the present invention, it is possible to accurately detect a position of the rotor of the motor by the hall sensor or the photo sensor by employing the BLDC motor, thereby precisely controlling a speed of the motor.

In addition, according to the fuel supply system of the LPI engine according to the exemplary embodiment of the present invention, it is possible to prevent excessive hydraulic pressure from being applied to the return line and the injector connected to the return line by applying the relief valve to the return line.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of a fuel supply system of an LPG engine in the related art.

FIG. 2 is a configuration diagram of an LPI engine fuel supply system according to an exemplary embodiment of the present invention.

FIG. 3 is a block diagram illustrating an LPG fuel pump control system according to an exemplary embodiment of the present invention.

FIG. 4 is a flowchart of an LPG fuel pump control method according to an exemplary embodiment of the present invention.

FIG. 5 is a graph of comparison of effects between the related art and an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

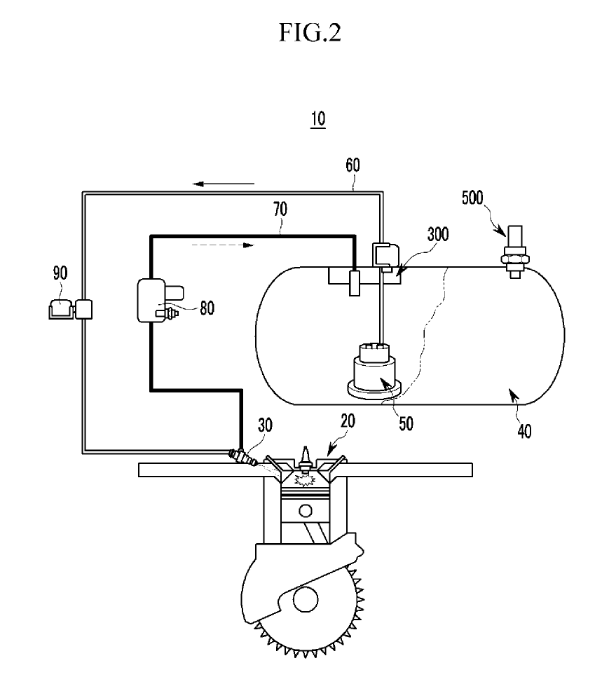

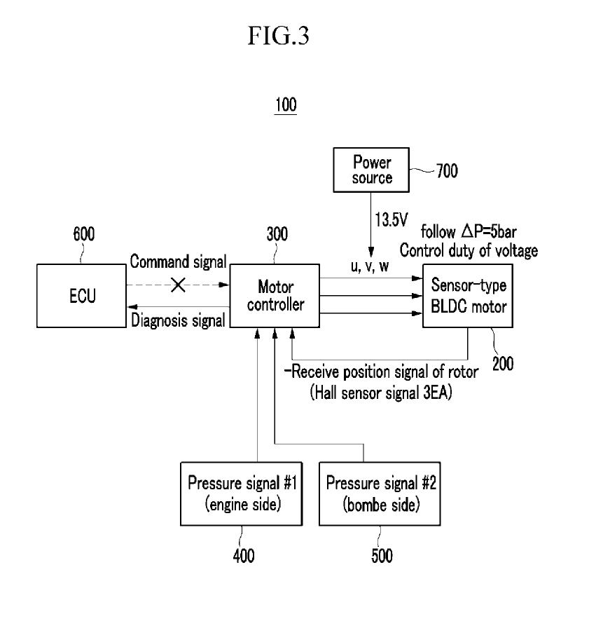

FIG. 2 is a configuration diagram of a fuel supply system 10 of an LPI engine according to an exemplary embodiment of the present invention, and FIG. 3 is a block diagram illustrating an LPG fuel pump control system 100 according to an exemplary embodiment of the present invention.

As shown in FIG. 2, the fuel supply system 10 of the LPI engine according to the exemplary embodiment of the present invention includes a bombe 40 in which an LPG fuel is stored, an LPG fuel pump 50 for delivering the fuel of the bombe 40 to an engine 20, a fuel supply line 60 for supplying the fuel from the bombe 40 to the engine 20, a fuel return line 70 communicated so that the fuel is collected from the engine 20 to an inside of the bombe 40, a relief valve 80, and a shut-off valve 90, and as illustrated in FIG. 3, the LPG fuel pump 50 may be controlled by an LPG fuel pump control system 100 according to the exemplary embodiment of the present invention.

The bombe 40 is a pressure resistant container made of steel for the purpose of storing, delivering, and using a liquefied petroleum gas (LPG) fuel, and is called a fuel tank.

The LPG fuel pump 50 serves to deliver the fuel inside the bombe 40 and may be installed inside the bombe 40 as illustrated in FIG. 2. However, the LPG fuel pump 50 is not limited thereto, and may be installed outside the bombe 40 to deliver the fuel of the bombe 40.

In one or multiple exemplary embodiments, the LPG fuel pump 50 may generally include a housing provided with an inlet and an outlet for introducing and discharging the fuel, a pump operated so that the LPG fuel flows in and is discharged, and a motor 200 for delivering driving force by a rotation to the pump. In one or multiple exemplary embodiments, the motor 200 may include a rotor, a stator, and a rotation shaft, and rotates while being connected with an external power source 700 to operate the pump and deliver the fuel.

However, the LPG fuel pump 50 according to the exemplary embodiment of the present invention is not limited to the aforementioned configuration, and the LPG fuel pump 50 corresponds to a widely known technology, so that detailed descriptions of the respective constituent elements will be omitted.

The fuel supply line 60 is installed in the bombe 40 to supply the fuel delivered by the LPG fuel pump 50 to the injector 30 of the engine 20. The shut off valve 90 for preventing an overflow may be installed at the fuel supply line 60.

The injector 30 is a precise valve in a solenoid type for spraying the accurate amount of fuel toward an intake valve of the engine in an optimum spray state for a fuel spray time calculated from an electronic control unit (ECU) 600 according to a condition of a vehicle.

In the meantime, the return line 70 is communicated so that the fuel is collected from the engine 20 to the inside of the bombe 40. The fuel as much as a difference between the amount of fuel delivered by the LPG fuel pump 50 and the amount of fuel consumed by the engine 20 is collected to the bombe 40 through the return line 70 as a return flow rate.

The relief valve 80 is installed at the return line 70 so as to uniformly maintain hydraulic pressure of the return line 70. When the pressure of the return line 70 is equal to or larger than predetermined pressure, the relief valve 80 discharges the fuel to maintain the pressure of the return line 70 in a level equal to or less than a set value.

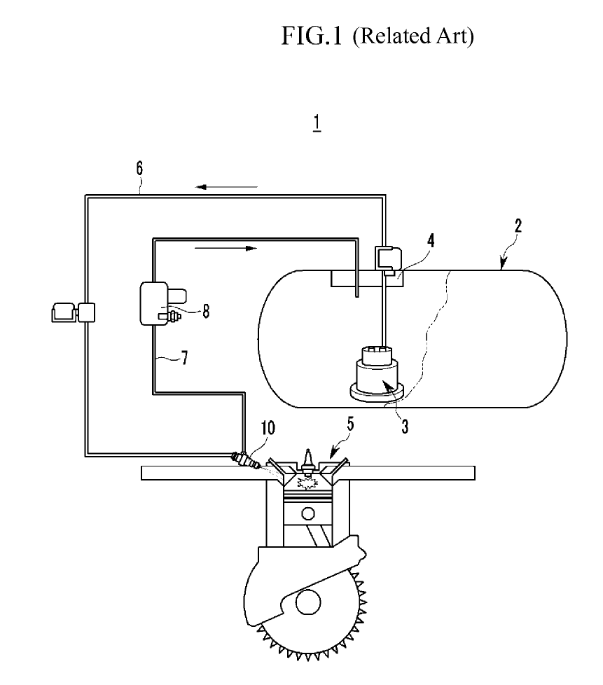

In the related art, as illustrated in FIG. 1, the regulator valve 8 is employed instead of the relief valve 80, but when a flow rate is large, there is a problem in that large pressure is applied to the return line or the injector. Accordingly, in the exemplary embodiment of the present invention, the valve is changed to the relief valve 80 instead of the regulator valve so as to prevent the application of excessive pressure to the return line 70 and the injector 30.

In the meantime, the LPG fuel pump 50 is controlled by the LPG fuel pump control system 100 according to the exemplary embodiment of the present invention illustrated in FIG. 3.

As illustrated in FIG. 3, the LPG fuel pump control system 100 according to the exemplary embodiment of the present invention includes the motor 200, a motor controller 300, an engine-side pressure sensor 400, and a bombe-side pressure sensor 500.

As described above, the motor 200 is a part which is installed inside the LPG fuel pump 50 to drive the fuel pump 50 through a rotation by the external power source 700.

According to the exemplary embodiment of the present invention, the motor 200 may be a sensor-type BLDC motor in which a hall sensor or a photo sensor for detecting a rotation position of an internal rotor is installed.

The BLDC motor is an abbreviation of a Brushless DC motor, and has high efficiency and is easily controlled compared to other motors, so that the BLDC motor is used so as to implement variable speed operation.

In order to operate the BLDC motor that is a blushless DC motor, it is necessary to control a flux of magnetic force of the stator so as to electrically form a right angle or a predetermined angle with respect to a flux of a permanent magnet generated in the rotor. To this end, it is necessary to always detect a position of the rotor and determine switching states of inverter switching devices so as to determine a generation position of the flux of the magnetic force of the stator according to the position of the rotor. That is, the BLDC motor is a DC motor in which a field pole is disposed as a coil having a three-phase motor structure by using the rotor as a permanent magnet without a brush and a commutator, and the position of the rotor is detected by the hall sensor or the photo sensor to cut a current flowing in a corresponding field coil by using a power element, such as a field effect transistor (FET), and induce intake repulsion between a rotation magnet and a fixed coil achieve rotation.

The position information of the rotor detected by the hall sensor or the photo sensor is transmitted to the motor controller 300.

The motor controller 300 is a part for controlling a duty, a speed (rpm), and the like of the motor 200 and controls the amount of fuel delivery of the fuel pump 50 by controlling the speed of the motor 200. Accordingly, the motor controller 300 may be the fuel pump controller 300.

In one or multiple exemplary embodiments, the motor controller 300 may be installed inside the bombe 40 as illustrated in FIG. 2.

The motor controller 300 receives a position signal of the rotor measured by the hall sensor or the photo sensor of the motor 200 to measure the speed (rpm) of the motor 200. Accordingly, the speed of the motor 200 may be precisely controlled by accurately detecting the rotation position of the rotor of the motor. Contrary to this, since a position signal of the rotor of the motor is received by using back electromotive force in the related art, there is a problem in that the position of the rotor is not accurately detected.

The engine-side pressure sensor 400 measure pressure of the injector 30 installed at the engine 20 and transmits pressure information to the motor controller 300. The engine-side pressure sensor 400 may be installed adjacent to the injector 30. Further, the engine-side pressure sensor 400 may self-diagnose a disorder and output a diagnosis signal.

The bombe-side pressure sensor 500 measures pressure of the LPG bombe 40 and transmits pressure information to the motor controller 300. Accordingly, as illustrated in FIG. 2, the bombe-side pressure sensor 500 may be installed at a partial portion of the bombe 40. The bombe-side pressure sensor 500 may self-diagnose a disorder and output a diagnosis signal.

The motor controller 300 controls the speed (rpm) of the motor 200 so that a difference between the pressure of the LPG bombe 40 received from the bombe-side pressure sensor 500 and the pressure of the injector 30 received from the engine-side pressure sensor 400 is maintained as a predetermined value.

Particularly, the motor controller 300 controls the sped (rpm) of the motor 200 by changing the duty of the motor 200.

In one or multiple exemplary embodiments, the predetermined value may be 3 to 7 bars, and the predetermined value is set to 5 bars as an exemplary embodiment, which will be described below.

The position information on the rotor of the motor 200 is transmitted to the motor controller 300 through the hall sensor or the photo sensor, so that the speed (rpm) of the motor 200 may be precisely controlled.

That is, in the related art, the speed (rpm) of the motor is controlled by setting a flow rate of the LPG fuel pump from the first step to the fifth step, so that it is difficult to control the motor at a lower speed (rpm) than that of the first step. However, according to an exemplary embodiment of the present invention, the speed (rpm) of the motor 200 is controlled by changing the duty of the motor 200 by a stepless method in which a step is not set, and the speed of the motor 200 is accurately measured by the hall sensor, and the like, in real time, so that it is possible to precisely control the speed (rpm) of the motor and control so as to minimize the speed of the motor 200.

Accordingly, the return flow rate may be decreased by decreasing a driving speed (rpm) of the motor 200 in a low load idle section of the engine 20. Since the return flow rate is decreased, an increase in a temperature and pressure inside the LPG bombe 40 is suppressed, and a poor filling problem may be resolved when the LPG fuel is refilled.

In the meantime, the motor controller 300 may diagnose a disorder in driving the motor 200, as well as a disorder of the motor controller 300 and output a diagnosis signal.

In one or multiple exemplary embodiments, the motor controller 300 may transmit the diagnosis signals output from the engine-side pressure sensor 400 and the bombe-side pressure sensor 500 and the diagnosis signal of the motor controller 300 to the electronic control unit (ECU) 600 of a vehicle. When the ECU 600 of the vehicle identifies an over-voltage or open and short by receiving the diagnosis signals, the ECU 600 of the vehicle may terminate the control or change the duty of the motor 200.

Further, when the difference between the pressure of the LPG bombe 40 and the pressure of the injector 30 exceeds a range set from the predetermined value (5 bars) and is maintained for a predetermined time, the motor controller 300 may make the control by outputting a predetermined diagnosis signal and changing the duty of the motor 200.

For example, in a case where the predetermined value is 5 bars and a set range is a range within 1 bar from 5 bars, that is, a range from 4 to 6 bars, when the difference between the pressure of the bombe 40 and the pressure of the injector 30 is maintained as 7 bars or 3 bars for a predetermined time in spite of the aforementioned control, the pressure difference exceeds the set range (4 to 6 bars), so that it is determined that a problem is generated in the control. Accordingly, in this case, the motor controller 300 may handle the problem situation by outputting the diagnosis signal and decreasing the duty of the motor 200.

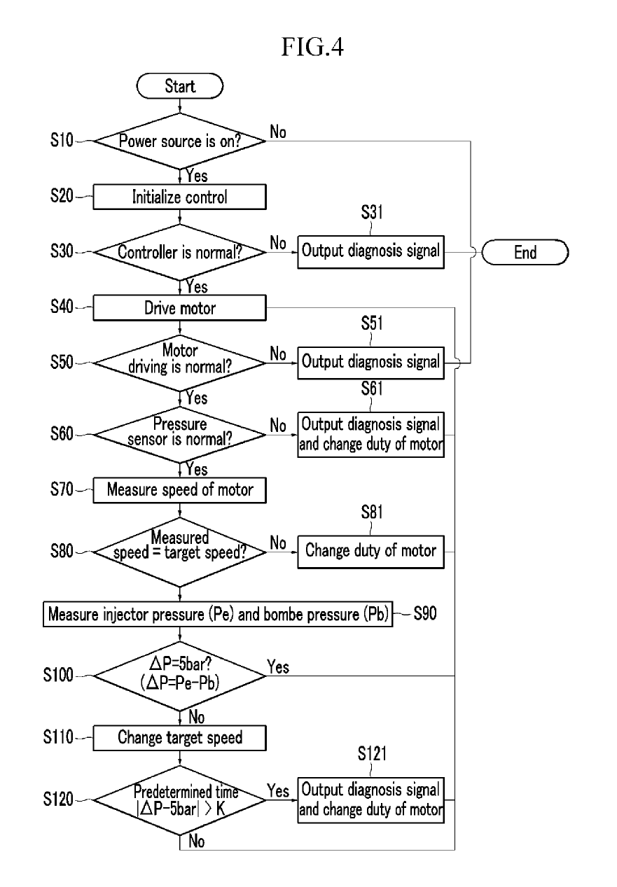

FIG. 4 is a flowchart of an LPG fuel pump control method according to an exemplary embodiment of the present invention. Hereinafter, the fuel pump control method according to the exemplary embodiment of the present invention will be described with reference to FIG. 4.

In step S10, it is determined whether a power source 700 is turned on. When the power source 700 is turned off, a control is terminated.

In step S20, when the power source 700 is turned on, a control is initialized. For example, the control may be initialized by setting a voltage duty of the motor 200 to 10% and a speed of the motor 200 to 1500 rpm.

In step S30, it is determined whether the motor controller 300 is in a normal state, and when the motor controller 300 is in an abnormal state, a predetermined diagnosis signal is output and the control is terminated in step S31.

In step S40, the motor 200 is driven with a voltage of the current duty.

In step S50, it is determined whether driving of the motor 200 is in a normal state. In step S51, when an overcurrent flows or open and short is identified in the motor 200, a predetermined diagnosis signal is output and the control is terminated. In one or multiple exemplary embodiments, whether the driving of the motor 200 is in the normal state may be determined by the motor controller 300, and the diagnosis signal may be transmitted to the ECU 600 of a vehicle.

In step S60, it is determined whether the engine-side pressure sensor 400 and the bombe-side pressure sensor 500 are in normal states. When any one or more of the engine-side pressure sensor 400 and the bombe-side pressure sensor 500 are in an abnormal state, a predetermined diagnosis signal is output and the duty of the motor 200 is changed in step S61 and the process returns to step S40 again. The ECU 600 of the vehicle may receive the pressure sensor diagnosis signal through the motor controller 300, and the ECU 600 of the vehicle may take follow-up measures by diagnosing a state of the pressure sensor.

In step S70, a speed (rpm) of the motor 200 is measured. In one or multiple exemplary embodiments, the motor 200 may be the BLDC motor in which the aforementioned hall sensor or photo sensor is installed. A position of the rotor of the motor 200 is accurately measured by the hall sensor or the photo sensor, so that the speed of the motor may be precisely controlled.

In step S80, the motor controller 300 determines whether the speed (rpm) of the motor 200 measured in step S70 reaches a set target speed (rpm). When the measured speed of the motor 200 does not reach the target speed, the motor controller 300 controls the measured speed of the motor to follow the target speed by changing the duty of the motor 200 in step S81 and performing step 40 again.

In step S90, whether the speed of the motor reaches the target speed, pressure (Pe) of the injector 30 of the engine 20 and pressure (Pb) of the bombe 40 are measured. The pressure (Pe) of the injector 30 may be measured by the engine-side pressure sensor 400, and the pressure (Pb) of the bombe 40 may be measured by the bombe-side pressure sensor 500.

In step S100, the motor controller 300 determines whether a difference between the pressure of the injector 30 and the pressure of the bombe 40 (ΔP=Pe−Pb) is maintained as a predetermined value. Here, the predetermined value may be 3 to 7 bars, and a case in which the predetermined value is 5 bars will be described as an example of the exemplary embodiment.

When the pressure difference ΔP between the injector 30 and the bombe 40 is maintained as 5 bars, the process returns to step S40 to drive the motor 200 with the duty of the current state.

In step S110, when pressure difference ΔP between the injector 30 and the bombe 40 is not 5 bars, the target speed (rpm) of the motor 200 is changed. When the target speed (rpm) of the motor 200 is changed, the measured speed of the motor follows the target speed accordingly. Therefore, the pressures are controlled so that the pressure difference ΔP becomes 5 bars.

In step S120, it is determined whether the difference ΔP between the pressure of the LPG bombe 40 and the pressure of the injector 30 exceeds a set range from the predetermined value (for example, 5 bars) and is maintained for a predetermined time.

In one or multiple exemplary embodiments, as illustrated in FIG. 4, when an absolute value of a difference between the pressure difference ΔP and the predetermined value is larger than a specific value K, it may be determined that the difference ΔP exceeds the set range. In one or multiple exemplary embodiments, the specific value K may be set to 1 bars.

When the difference ΔP between the pressure of the injector 30 and the pressure of the LPG bombe 40 does not exceed the set range from the predetermined value (for example, 5 bars), there is no problem in the control, so that the process returns to step S40.

When the difference ΔP between the pressure of the injector 30 and the pressure of the LPG bombe 40 exceeds the set range from the predetermined value and is maintained for the predetermined time, it is determined that the problem is generated. Accordingly, in this case, a problem situation is handled by outputting a diagnosis signal in step S121 and decreasing the duty of the motor 200.

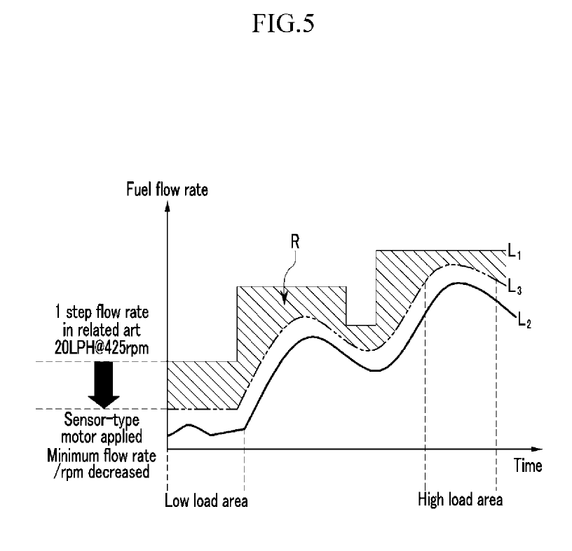

FIG. 5 is a graph of comparison of effects between the related art and the exemplary embodiment of the present invention.

L1 in the graph represents a change in a fuel pump delivery flow rate and a motor speed according to a change in the step when the LPG fuel pump is controlled with five steps in the related art, L2 represents the amount of fuel consumption of the engine, and L3 represents a change in a fuel pump delivery flow rate and a motor speed in a case of the LPG fuel pump control according to the exemplary embodiment of the present invention. The fuel pump delivery flow rate according to the exemplary embodiment of the present invention may be a sum of the fuel consumption of the engine and the safety rate.

As illustrated in FIG. 5, when the LPG fuel pump is controlled according to the exemplary embodiment of the present invention, the fuel pump delivery flow rate is precisely changed according to the amount of fuel consumed by the engine. Accordingly, the return flow rate may be decreased by an area R compared to the related art. Accordingly, the return flow rate may be minimized in the low load area, thereby achieving an effect in that an increase in a temperature and pressure of the LPG bombe may be suppressed and a filling failure may be prevented when the LPG fuel is refilled.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling a liquefied petroleum gas (LPG) fuel pump, comprising:
driving a motor of the LPG fuel pump with a voltage of a predetermined duty;
measuring a driving speed of the motor;
changing the predetermined duty of the motor so that the measured driving speed of the motor reaches a target speed when the measured driving speed of the motor is not equal to the target speed;
measuring pressure of an LPG bombe and pressure of an injector; and
changing the target speed when a first difference between the measured pressure of the LPG bombe and the measured pressure of the injector is not maintained as a first predetermined value.

2. The method of claim 1, further comprising:
determining whether a second difference between the first difference and the first predetermined value exceeds a second predetermined value and is maintained for a predetermined time; and
outputting a predetermined diagnosis signal and changing the duty of the motor, when the second difference is determined to exceed the second predetermined value for the predetermined time.

3. The method of claim 1,
wherein the pressure of the LPG bombe is measured by a pressure sensor installed at the LPG bombe,
wherein the pressure of the bombe is measured by a pressure sensor installed at an engine side, and
wherein the duty of the motor is changed by a motor controller.

4. The method of claim 3, wherein the motor controller, the pressure sensor installed at the bombe, and the pressure sensor installed at the engine side identify malfunctions and output diagnosis signals, respectively.

5. The method of claim 1, wherein the first predetermined value is 3 to 7 bars.

6. The method of claim 1, wherein the motor is a sensor-type Brushless direct current (BLDC) motor in which a hall sensor or a photo sensor configured to detect a rotation position of an internal rotor is installed, and the motor controller measures the driving speed of the motor by receiving a position signal of the rotor sensed by the hall sensor or the photo sensor.

7. A system of controlling a liquefied petroleum gas (LPG) fuel pump, comprising:
a motor controller configured to control driving of a motor installed inside the LPG fuel pump;
an engine-side pressure sensor configured to measure pressure of an injector installed at an engine to transmit the measured pressure to the motor controller; and
a bombe-side pressure sensor configured to measure pressure of an LPG bombe to transmit the measured pressure to the motor controller,
wherein the motor controller changes a duty of the motor so that a measured speed of the motor reaches a target speed, receives the measured pressure of the LPG bombe and the measured pressure of the injector, and changes the target speed of the motor so that a first difference between the pressure of the LPG bombe and the pressure of the injector is maintained as a predetermined value.

8. The system of claim 7, wherein when a second difference between the first difference and the first predetermined value exceeds a second predetermined value and is maintained for a predetermined time, the motor controller outputs a predetermined diagnosis signal and changes the duty of the motor.

9. The system of claim 7, wherein the motor is a sensor type Brushless direct current (BLDC) motor in which a hall sensor or a photo sensor configured to detect a rotation position of an internal rotor is installed, and the motor controller measures a speed of the motor by receiving a position signal of the rotor from the motor.

10. The system of claim 7, wherein the motor controller, the bombe-side pressure sensor, and the engine-side pressure sensor identify malfunctions and output diagnosis signals, respectively.

11. The system of claim 7, wherein the first predetermined value is 3 to 7 bars.

12. A fuel supply system of a liquefied petroleum injection (LPI) engine, including:
the LPG bombe in which an LPG fuel is stored;
the LPG fuel pump configured to deliver the fuel of the LPG bombe to the LPI engine;
a fuel supply line connected to the LPG fuel pump and to an injector and configured to supply the fuel to the injector of the engine from the LPG bombe; and
a fuel return line fluid-connected to the injector and the LPG bombe so that a fuel remaining in the injector is collected to an inside of the LPG bombe,
wherein the LPG fuel pump is controlled by the system for controlling the LPG fuel pump of claim 7.

13. The fuel supply system of claim 12, further including a relief valve installed at the return line to maintain pressure of the return line.

14. The fuel supply system of claim 12, further including a shut-off valve installed at the fuel supply line.
